(19) United States
(12) Patent Application Publication
(10) Pub. No.: US 2005/0058775 A1
(43) Pub. Date: Mar. 17, 2005

(54) Method and apparatus for forming coating film

(76) Inventors: Akio Oku, Kitakyushu-shi (JP); Yorikazu Sakamoto, Kitakyushu-shi (JP)

Correspondence Address: Finnegan, Henderson, Farabow,;Garrett & Dunner, L.L.P., 1300 I Street, N.W., Washington, DC, 20005-3315, US

(21) Appl. No.: 10/901,412

(22) Filed: Jul. 29, 2004

(30) Foreign Application Priority Data
Jul. 31, 2003 (JP) 2003-204753

(51) Int. Cl. B05D 1/00; B05D 3/12

(52) U.S. Cl. 427/240; 427/8; 118/52; 118/319

(57) ABSTRACT

A method of forming a coating film includes rotating a support member to rotate a target substrate in a horizontal state, and supplying a coating liquid onto a target surface from a supply port of a nozzle, while moving the nozzle in a horizontal direction relative to the target substrate being rotated. This method also includes detecting a height of the target surface, and controlling a vertical position of the nozzle, based on a detected height of the target surface, to satisfy a formula, (S/R)>D>0, when supplying the coating liquid. In the formula, S denotes an area of the supply port, R denotes an inner perimeter of the supply port, and D denotes a distance between the supply port and the target surface.

### CROSS-REFERENCE TO RELATED APPLICATIONS

This application is based upon and claims the benefit of priority from prior Japanese Patent Application No. 2003-204753, filed Jul. 31, 2003, the entire contents of which are incorporated herein by reference.

### BACKGROUND OF THE INVENTION

1. Field of the Invention

The present invention relates to a method and apparatus for forming a coating film, such as a polyimide film, on a target substrate, such as a semiconductor wafer. Particularly, the present invention relates to a method and apparatus used for subjecting a target substrate to a predetermined semiconductor process. The term “semiconductor process” used herein includes various kinds of processes which are performed to manufacture a semiconductor device or a structure having wiring layers, electrodes, and the like to be connected to a semiconductor device, on a substrate, such as a semiconductor wafer or an glass substrate for an LCD (Liquid crystal display) or FPD (Flat Panel Display), by forming semiconductor layers, insulating layers, and conductive layers in predetermined patterns on the substrate.

2. Description of the Related Art

In manufacturing semiconductor devices, a spin coating method is known as a method of forming a coating film, such as a polyimide film, which is used as an insulating film or protection film. Where a spin coating method is performed, a target substrate, such as a semiconductor wafer, is fixed on a support member (spin chuck) that can rotate at a high speed. Then, the target substrate is supplied with a coating liquid from a nozzle, and is rotated at a high speed. In this method, the centrifugal force caused by the high speed rotation helps to form a coating film of a uniform film thickness.

Jpn. Pat. Appln. KOKAI Publication No. 2002-320902 discloses a spin coating method, in which a coating liquid is supplied in a helical shape extending from the center of a target substrate. This method can reduce wastage of the coating liquid.

However, according to the present inventors, several problems have been found in conventional spin coating methods, and these are described in more detail later. For example, these problems relate to the operation efficiency of an apparatus, the consumption efficiency of a coating liquid, and the planar uniformity of a coating film to be formed.

### BRIEF SUMMARY OF THE INVENTION

According to a first aspect of the present invention, there is provided a method of forming a coating film, the method comprising:
placing a target substrate having a target surface on a support member in a substantially horizontal state;
rotating the support member to rotate the target substrate in a substantially horizontal state;
supplying a coating liquid onto the target surface from a supply port of a nozzle, while moving the nozzle in a horizontal direction relative to the target substrate being rotated;
detecting a height of the target surface; and
controlling a vertical position of the nozzle, based on a detected height of the target surface, to satisfy a formula, (S/R)>D>0, when supplying the coating liquid, where S denotes an area of the supply port, R denotes an inner perimeter of the supply port, and D denotes a distance between the supply port and the target surface.

According to a second aspect of the present invention, there is provided an apparatus for forming a coating film, the apparatus comprising:
a support member configured to place a target substrate having a target surface thereon in a substantially horizontal state;
a rotation drive configured to rotate the support member to rotate the target substrate in a substantially horizontal state;
a nozzle having a supply port configured to supply a coating liquid onto the target surface;
a horizontal movement drive configured to move the nozzle in a horizontal direction;
a detector configured to detect a height of the target surface;
a vertical movement drive configured to move the nozzle in a vertical direction; and
a controller configured to control an operation of the apparatus,
wherein the controller executes
rotating the support member to rotate the target substrate in a substantially horizontal state, and supplying the coating liquid onto the target surface from the supply port of the nozzle, while moving the nozzle in the horizontal direction relative to the target substrate,
detecting a height of the target surface by the detector, and
controlling a vertical position of the nozzle, based on a detected height of the target surface, to satisfy a formula, (S/R)>D>0, when supplying the coating liquid, where S denotes an area of the supply port, R denotes an inner perimeter of the supply port, and D denotes a distance between the supply port and the target surface.

### BRIEF DESCRIPTION OF THE SEVERAL VIEWS OF THE DRAWING

FIG. 1 is a perspective view showing the entire structure of a coating apparatus (spin coater) according to an embodiment of the present invention;

FIG. 2 is a schematic plan view showing a manner of applying liquid polyimide in a helical shape onto a target surface; and

FIG. 3 is a sectional side view schematically showing a conventional coating apparatus (spin coater) used for forming a coating film, such as a polyimide film.

### DETAILED DESCRIPTION OF THE INVENTION

In the process of developing the present invention, the inventors studied the problems in conventional spin coating methods, and particularly the problems associated with polyimide film formation. As a result, the inventors have arrived at the findings given below.

FIG. 3 is a sectional side view schematically showing a conventional coating apparatus (spin coater) used for forming a coating film, such as a polyimide film. As shown in FIG. 3, the apparatus has a support member (spin chuck) 102 to place and fix thereon a target substrate 101, such as a semiconductor wafer. The support member 102 can be rotated at a high speed by a rotation drive 104. A nozzle 108 for supplying a coating liquid 109 is movably disposed above the support member 102. A cup 118 is disposed around the support member 102 to catch the coating liquid splashed around during rotation of the support member 102.

When a coating film is formed, the target substrate 101 is fixed on the support member 102, as shown in FIG. 3. Then, the coating liquid 109 is supplied from the nozzle 108 onto the target substrate 101. Then, the support member 102 is rotated at a high speed along with the target substrate 101 by the rotation drive 104. As a consequence, the coating liquid is uniformly spread on the target substrate 101 by the centrifugal force caused by the high speed rotation, and a coating film of a uniform film thickness is thereby formed.

According to this spin coating method, however, the amount of coating liquid splashed into the cup 118 is large, and some of the coating liquid seeps under the bottom of the target substrate 101. As a result, problems arise such that (1) wastage of the coating liquid is large, which reduces the consumption efficiency of the coating liquid, (2) the cup requires to be periodically replaced or cleaned, and (3) the bottom of the target substrate needs to be cleaned of the coating liquid sticking thereto. On the other hand, according to a method of applying a coating liquid in a helical shape, as disclosed in Jpn. Pat. Appln. KOKAI Publication No. 2002-320902, the coating liquid is hardly uniformly spread on the target substrate 101. As a result, it is difficult to form a coating film having a film thickness with a high planar uniformity.

Embodiments of the present invention achieved on the basis of the findings given above will now be described with reference to the accompanying drawings. In the following description, the constituent elements having substantially the same function and arrangement are denoted by the same reference numerals, and a repetitive description will be made only when necessary.

### FIRST EMBODIMENT

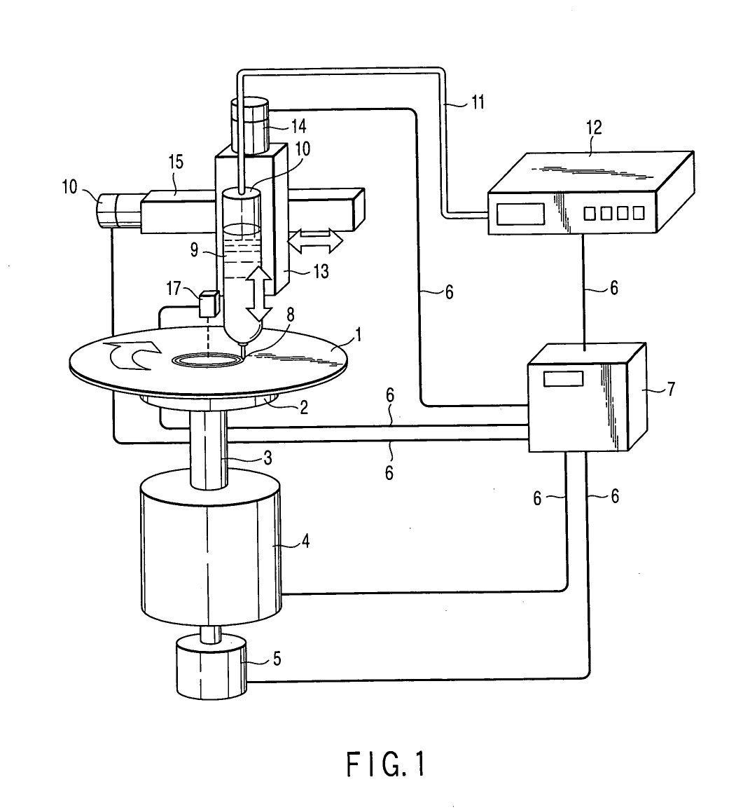

FIG. 1 is a perspective view showing the entire structure of a coating apparatus (spin coater) according to an embodiment of the present invention. As shown in FIG. 1, this apparatus has a support member (vacuum spin chuck) 2 configured to place and fix thereon a circular target substrate 1, such as a semiconductor wafer (of, e.g., 6 inches). The target substrate 1 is concentrically fixed on the support member 2 while it faces upward in a horizontal state. The support member 2 is formed of a circular metal plate having a top face arranged as a vacuum suction face with a diameter of, e.g., 110 mm. The vacuum suction face is provided with a plurality of suction holes, so that a target substrate 1 can be fixed by a vacuum suction force. In order to reliably hold the target substrate 1 in a horizontal state, the vacuum suction face of the support member 2 has an area not less than a quarter of the target substrate 1 (the diameter is not less than a half of the target substrate).

The support member 2 is connected to a rotation drive 4 including, e.g., a rotary motor, through a rotary shaft 3. The rotation drive 4 integratedly rotates the support member 2 and target substrate 1, so as to rotate the target substrate 1 in a horizontal state. A detector 5 for detecting the rotation angle of the support member 2 is connected to the rotation drive 4. The rotation drive 4 and detector 5 are connected to a controller 7 through signal transmission lines 6. The controller 7 controls the rotation drive 4 to rotate the support member 2 and target substrate 1.

A nozzle 8 is disposed above the support member 2 to supply liquid polyimide (coating liquid) 9 onto a target surface of the target substrate 1. The supply port of the nozzle 8 for delivering the liquid polyimide 9 has an inner diameter of, e.g., 2.27 mm. The nozzle 8 is connected to the bottom of a syringe 10 that stores the liquid polyimide 9. A flow passage 11 is connected to the top of the syringe 10 to supply a pressurizing gas into the syringe 10. The flow passage 11 is connected to a liquid control unit 12, which adjusts the pressurizing gas to control the delivery amount (supply amount) of the liquid polyimide from the nozzle 8.

The syringe 10 is attached to a vertical movement drive 13, which moves the syringe 10 and nozzle 8 integratedly in the vertical direction. The vertical movement drive 13 includes a motor 14 connected to the controller 7 through a signal transmission line 6. The controller 7 controls the vertical movement drive 13 to move the syringe 10 and nozzle 8 in a vertical direction.

The vertical movement drive 13 is attached to a horizontal movement drive 15, which moves the syringe 10 and nozzle 8 along with the vertical movement drive 13 integratedly in a horizontal direction. The horizontal movement drive 15 includes a motor 16 connected to the controller 7 through a signal transmission line 6. The controller 7 controls the horizontal movement drive 15 to move the syringe 10 and nozzle 8 in a horizontal direction.

A detector 17 for detecting the height of the target surface on the target substrate 1 is fixed to the side of the casing of the vertical movement drive 13 near the syringe 10. Accordingly, the detector 17 is moved by the horizontal movement drive 15, integratedly with the syringe 10 and nozzle 8 in a horizontal direction. The detector 17 is formed of an optical sensor or electric capacitance sensor, and aims at a portion of the target surface directly below it as a detection target. The detector 17 is connected to the controller 7 through a signal transmission line 6.

The detector 17 and nozzle 8 are arranged adjacent to each other along almost the same circular arc whose center is the rotational center of the support member 2. The detector 17 is disposed immediately before the supply port in the rotational direction of the support member 2. Accordingly, a detection position, where the height of the target surface is detected, is set to be immediately ahead of the supply port in the relative movement direction between the supply port of the nozzle 8 and the target surface, when the liquid polyimide 9 is supplied in a manner described later.

Next, an explanation will be given of a method of forming a polyimide film by the coating apparatus shown in FIG. 1.

At first, a circular target substrate 1, such as a semiconductor wafer, is placed and fixed on the support member 2. The target substrate 1 is horizontally and concentrically fixed on the support member 2 while it faces upward. Then, the nozzle 8 is moved by the horizontal movement drive 15 to a supply start position above the target substrate 1 (for example, the center of the target substrate). Then, the nozzle 8 is moved down by the vertical movement drive 13 to set the distance D between the nozzle 8 and the target surface of the target substrate 1 to a predetermined value of, e.g., 30 μm, (the initial height).

On the other hand, before the nozzle 8 is moved down, the support member 2 starts being rotated (so does the target substrate 1) by the rotation drive 4, at a rotational speed controlled by the controller 7. Then, at the moment when the nozzle 8 reaches the lower dead point (the initial height), the liquid polyimide 9 starts being supplied from the nozzle 8, and the nozzle 8 starts being moved in a horizontal direction. In this operation, the controller 7 controls rotation of the support member 2 and movement of the nozzle 8 to apply the liquid polyimide 9 in a helical shape onto the target surface.

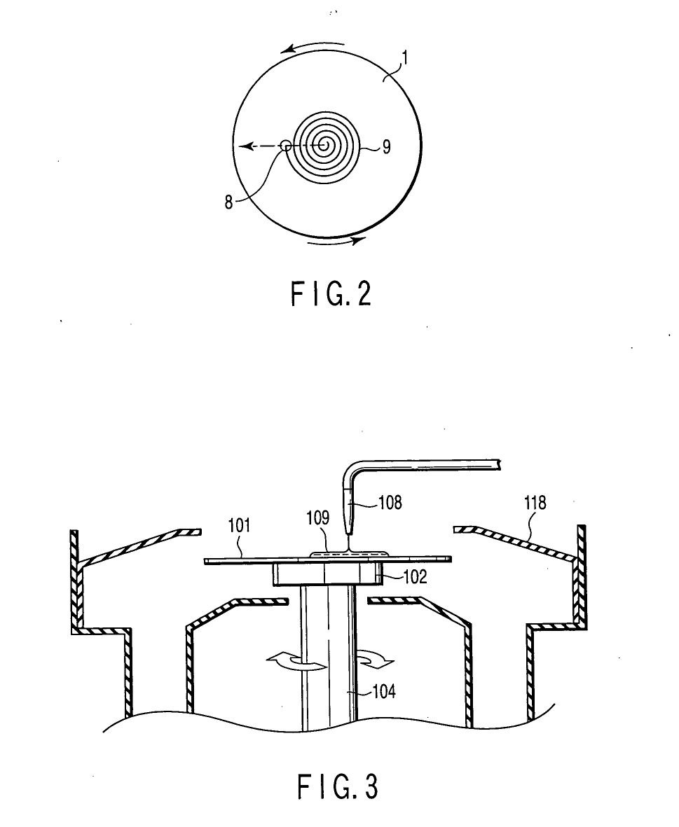

FIG. 2 is a schematic plan view showing a manner of applying the liquid polyimide 9 in a helical shape onto the target surface. As shown in FIG. 2, while the target substrate 1 rotates, the nozzle 8 is moved from the rotational center of the target substrate 1 toward the periphery thereof in a horizontal direction (along a straight line in this embodiment). As a consequence, the liquid polyimide 9 is applied onto the target surface, such that it forms a helical shape extending from the rotational center of the target substrate to the periphery thereof.

Although FIG. 2 shows the helical shape as a line, the liquid polyimide 9 is actually supplied as a belt (whose width is determined by the size of the supply port of the nozzle 8). Accordingly, it is possible to prevent a gap from being formed between turns of the liquid polyimide 9 belt forming a helical shape, by suitably setting the moving distance of the nozzle 8 in a horizontal direction given for each turn of the target substrate 1, in light of the width of the liquid polyimide 9 belt. By doing so, the liquid polyimide 9 can be applied over the entire target surface.

Furthermore, the controller 7 controls supply of the liquid polyimide 9 from the supply port of the nozzle 8, rotation of the support member 2, and movement of the nozzle 8, such that the supply rate of the liquid polyimide 9 onto the target surface is kept constant. For example, where the supply start position is set at the rotational center of the target substrate 1, the supply amount of the liquid polyimide 9 and the moving speed of the nozzle 8 in the horizontal direction are kept constant, while the rotational speed of the support member 2 is changed. More specifically, the rotational speed of the support member 2 is changed, such that it is gradually reduced in accordance with the movement of the nozzle 8, e.g., from 400 rpm when the nozzle 8 starts at the center of the target surface, to 100 rpm when the nozzle 8 reaches the peripheral edge of the target surface.

The support member 2 is formed of a metal member machined to have horizontal flatness with high accuracy, and whose vacuum suction face has an area not less than a quarter of the target substrate 1 (the diameter is not less than a half of the target substrate 1). Since the target substrate 1 is attracted and held on such a support member 2, it is possible to suppress fluctuations in the height of the target surface to be 30 μm or less, wherein the fluctuations are due to variation in the thickness of the target substrate 1, deformation of the support member 2, and rotation at a speed of 100 rpm or more.

However, even such small fluctuations can affect the planer uniformity in the thickness of a coating film. In order to solve this problem, the detector 17 is used to detect the height of the target surface at a position immediately before a position where the liquid polyimide is supplied from the supply port of the nozzle 8 (which will be referred to as a supply position). Furthermore, the detector 5 is used to detect an angular difference between the supply position and a position where the height of the target surface is detected (which will be referred to as a detection position). In other words, the detector 5 detects that angle about the rotational center of the target surface, which is formed between the supply port of the nozzle 8 and the detection point of the detector 17, where they are imaginarily projected on the target surface.

These detection results are transmitted to the controller 7, and used to control the distance D to be constant (for example, 30 μm) between the supply port of the nozzle 8 and the target surface. Specifically, the controller 7 controls the vertical position of the nozzle 8 such that the distance D is constant between the supply port of the nozzle 8 and a portion whose height has been detected (which will be referred to as a detected portion), when the detected portion comes directly below the supply port. In this case, the controller 7 operates the vertical movement drive 13 for the nozzle 8 on the basis of the detection results in light of the rotational speed of the support member 2 and the moving speed of the nozzle 8 in the horizontal direction.

As described above, the liquid polyimide 9 is supplied onto the target surface from the nozzle 8, while the distance D between the nozzle 8 and target surface is controlled to be constant. During this time, the liquid control unit 12 controls the delivery pressure through the pressurizing gas flow passage 11 onto the liquid polyimide 9 in the syringe 10, so as to supply the liquid polyimide 9 at a constant supply amount. Since the distance D between the nozzle 8 and target surface is sufficiently small relative to the inner diameter of the supply port of the nozzle, a certain friction is generated between the liquid polyimide and target substrate while the liquid polyimide is being supplied. As a consequence, the liquid polyimide can be uniformly applied onto the target substrate 1.

As described above, the liquid polyimide 9 is applied in a helical shape with a uniform width, from the center of the target substrate 1 toward the periphery thereof (see FIG. 2). At this time, the moving speed of the nozzle 8 in a horizontal direction is suitably controlled to coat the entire target surface uniformly with the minimum amount of the liquid polyimide 9 necessary for forming a thin film. Then, the solvent is evaporated, and a polyimide film having a uniform thickness is thereby formed on the target surface.

According to the method described above, the amount of liquid polyimide supplied onto the target substrate 1 can be the minimum necessary to form a thin film. It is thus possible to prevent problems of the prior art, in that the amount of a coating liquid splashed into the cup is large, and some of the coating liquid seeps under the bottom of a target substrate. As a consequence, the operation efficiency of the apparatus and the consumption efficiency of a coating liquid are improved.

The distance D between the nozzle 8 and target surface does not necessarily have to be constant. Specifically, when the liquid polyimide 9 is supplied, the vertical position of the nozzle 8 may be controlled to satisfy the following formula, on the basis of a detected height of the target surface. For example, the controller 7 controls the vertical position of the nozzle 8 to satisfy the following formula when the detected portion of the target surface comes directly below the supply port, on the basis of a height of the detected portion, with reference to the positional relationship between the detection position and supply position in the relative movement direction between the supply port of the nozzle 8 and the target surface.
(S/R)>D>0
where S denotes the area of the supply port of the nozzle 8, R denotes the inner perimeter of the supply port, and D denotes the distance between the supply port and target surface.

In the formula set out above, where the supply port of the nozzle 8 is circular, D is smaller than a half of the radius r of the supply port (i.e., smaller than a quarter of the diameter). If D is equal to or greater than S/R, it is difficult for the liquid polyimide to have a sufficient friction with the target substrate. On the other hand, as a matter of course, D is larger than zero to supply the coating liquid. Furthermore, D is preferably controlled to be 2 to 10% of r in light of the productivity and planer uniformity, and more preferably controlled to be 1 to 5% of r in light of the planer uniformity.

The height of the target surface may be measured by a detector in advance, to perform coating later on the basis of the measurement results. In this case, since height fluctuations of a target surface differ among target substrates, the measurement is required for every target substrate. Where a plurality of nozzles are used for coating, each of the nozzles is provided with a vertical movement drive.

According to this embodiment, the rotational speed of a target substrate and the moving speed of the nozzle in a horizontal direction are controlled to maintain constant the supply rate of a coating liquid onto the target surface at a supply position. Instead, the amount of a coating liquid supplied from the supply port of the nozzle may be controlled to maintain constant the supply rate of the coating liquid onto the target surface at a supply position.

The support member has a vacuum suction face with a predetermined area or more relative to a target substrate. Specifically, the vacuum suction face has an area larger than a quarter of the area of a target substrate (i.e., in the case of a circular shape, the vacuum suction face has a diameter lager than a half of the diameter of the target substrate). If the vacuum suction face of a support member is so large that it is exposed around a target substrate, the support member receives scattered coating liquid and thus requires cleaning. For this reason, the vacuum suction face of the support member is preferably set to be smaller than the target substrate (i.e., in the case of a circular shape, the vacuum suction face preferably has a diameter smaller than that of the target substrate).

### SECOND EMBODIMENT

Also in the second embodiment, a polyimide film is formed on the target surface of a target substrate 1, as in the first embodiment. In the second embodiment, however, the liquid polyimide is applied in a helical shape onto the target surface such that turns of the liquid polyimide belt partly overlap with each other, under the control of the controller 7. Specifically, the moving distance (for example, 1.00 mm) of the nozzle 8 in a horizontal direction given for each turn of the target substrate 1 is set smaller than the inner diameter (for example, 2.27 mm) of the supply port of the nozzle 8. By doing so, it is set to cause the turns of the liquid polyimide 9 belt to overlap with each other by a predetermined width of e.g., a half thereof or more.

According to this embodiment, each turn of the liquid polyimide belt applied from the supply port of the nozzle 8 can have a smaller rising on both sides of the nozzle 8 (the lateral sides relative to the supplying direction), because they are leveled by the following turn of the belt (or by the nozzle 8). As a consequence, the planer uniformity in film thickness can be further improved, in addition to the effect provided by the first embodiment.

### THIRD EMBODIMENT

Also in the third embodiment, a polyimide film is formed on the target surface of a target substrate 1, as in the first embodiment. In the third embodiment, however, after the liquid polyimide is entirely applied, the support member 2 and target substrate 1 are rotated at a speed higher than that in supplying the liquid polyimide, under the control of the controller 7. By doing so, even if supplying the liquid polyimide causes some unevenness in film thickness, it is leveled by the centrifugal force, and the planer uniformity in film thickness can be further improved.

The rotational speed of the high speed rotation is set to be preferably 2000 to 4000 rpm, and more preferably 2500 to 3500 rpm, although it can provide some effect where it is higher than that in supply. If the rotational speed is less than 2000 rpm, it can provide some effect, but cannot provide sufficient planer uniformity in film thickness. On the other hand, if the rotational speed is more than 4000 rpm, the load on the rotation mechanism increases and makes it difficult to maintain the horizontal rotation with high accuracy.

A polyimide film formed on a target substrate according to the first to third embodiments is used as an insulating film or protection film in semiconductor devices, for example. The present invention may be applied to a case where a photoresist film, another polymer film, or a color filter is formed, in place of a polyimide film. The target substrate is not limited to a semiconductor wafer, but may be another target substrate, such as a glass substrate.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A method of forming a coating film, the method comprising:
placing a target substrate having a target surface on a support member in a substantially horizontal state;
rotating the support member to rotate the target substrate in a substantially horizontal state;
supplying a coating liquid onto the target surface from a supply port of a nozzle, while moving the nozzle in a horizontal direction relative to the target substrate being rotated;
detecting a height of the target surface; and
controlling a vertical position of the nozzle, based on a detected height of the target surface, to satisfy a formula, (S/R)>D>0, when supplying the coating liquid, where S denotes an area of the supply port, R denotes an inner perimeter of the supply port, and D denotes a distance between the supply port and the target surface.

2. The method according to claim 1, wherein detecting a height of the target surface is performed when supplying the coating liquid, such that a detection position, where the height of the target surface is detected, is set to be immediately ahead of the supply port in a relative movement direction between the supply port and the target surface.

3. The method according to claim 2, further comprising moving a detector configured to detect a height of the target surface, together with the nozzle, in the horizontal direction, when supplying the coating liquid.

4. The method according to claim 2, wherein controlling a vertical position of the nozzle is performed to satisfy the formula when a detected portion comes directly below the supply port, based on a height of the detected portion, with reference to a positional relationship between the detection position and the supply position in the relative movement direction between the supply port and the target surface.

5. The method according to claim 1, wherein the coating liquid is supplied as a belt from the supply port, and rotation of the support member and movement of the nozzle are controlled to apply the coating liquid onto the target surface in a helical shape extending from a rotational center of the target substrate.

6. The method according to claim 5, wherein rotation of the support member and movement of the nozzle are controlled to cause turns of the belt of the coating liquid to partly overlap with each other on the target surface.

7. The method according to claim 1, wherein controlling a vertical position of the nozzle is performed to maintain the distance D constant when supplying the coating liquid.

8. The method according to claim 1, wherein supply of the coating liquid from the supply port, rotation of the support member, and movement of the nozzle are controlled to maintain constant a supply rate of the coating liquid onto the target surface.

9. The method according to claim 1, further comprising, after supplying the coating liquid, rotating the support member to rotate the target substrate at a speed higher than that in supplying the coating liquid.

10. The method according to claim 1, wherein the coating liquid comprises polyimide.

11. An apparatus for forming a coating film, the apparatus comprising:
a support member configured to place a target substrate having a target surface thereon in a substantially horizontal state;
a rotation drive configured to rotate the support member to rotate the target substrate in a substantially horizontal state;
a nozzle having a supply port configured to supply a coating liquid onto the target surface;
a horizontal movement drive configured to move the nozzle in a horizontal direction;
a detector configured to detect a height of the target surface;
a vertical movement drive configured to move the nozzle in a vertical direction; and
a controller configured to control an operation of the apparatus,
wherein the controller executes
rotating the support member to rotate the target substrate in a substantially horizontal state, and supplying the coating liquid onto the target surface from the supply port of the nozzle, while moving the nozzle in the horizontal direction relative to the target substrate,
detecting a height of the target surface by the detector, and
controlling a vertical position of the nozzle, based on a detected height of the target surface, to satisfy a formula, (S/R)>D>0, when supplying the coating liquid, where S denotes an area of the supply port, R denotes an inner perimeter of the supply port, and D denotes a distance between the supply port and the target surface.

12. The apparatus according to claim 11, wherein the controller detects a height of the target surface when supplying the coating liquid, and the detector sets a detection position, where the height of the target surface is detected, to be immediately ahead of the supply port in a relative movement direction between the supply port and the target surface.

13. The apparatus according to claim 12, wherein the detector is moved together with the nozzle, in the horizontal direction, when supplying the coating liquid.

14. The apparatus according to claim 12, wherein the controller controls a vertical position of the nozzle to satisfy the formula when a detected portion comes directly below the supply port, based on a height of the detected portion, with reference to a positional relationship between the detection position and the supply position in the relative movement direction between the supply port and the target surface.

15. The apparatus according to claim 11, wherein the nozzle supplies the coating liquid as a belt from the supply port, and the controller controls rotation of the support member and movement of the nozzle to apply the coating liquid onto the target surface in a helical shape extending from a rotational center of the target substrate.

16. The apparatus according to claim 15, wherein the controller controls rotation of the support member and movement of the nozzle to cause turns of the belt of the coating liquid to partly overlap with each other on the target surface.

17. The apparatus according to claim 11, wherein the controller controls a vertical position of the nozzle to maintain the distance D constant when supplying the coating liquid.

18. The apparatus according to claim 11, wherein the controller controls supply of the coating liquid from the supply port, rotation of the support member, and movement of the nozzle to maintain constant a supply rate of the coating liquid onto the target surface.

19. The apparatus according to claim 11, the controller further executes, after supplying the coating liquid, rotating the support member to rotate the target substrate at a speed higher than that in supplying the coating liquid.

20. The apparatus according to claim 11, wherein the coating liquid comprises polyimide.
